(19) United States
(12) Patent Application Publication
(10) Pub. No.: US 2018/0352847 A1
(43) Pub. Date: Dec. 13, 2018

(54) SUPPORT STRUCTURE FOR EDIBLE MATERIALS

(71) Applicant: Kendra Brown, Greenwood, IN (US)

(72) Inventor: Kendra Brown, Greenwood, IN (US)

(21) Appl. No.: 16/001,905

(22) Filed: Jun. 6, 2018

Related U.S. Application Data
(60) Provisional application No. 62/516,247, filed on Jun. 7, 2017.

(51) Int. Cl. A23P 10/10; A21B 3/13; A21D 13/47

(52) U.S. Cl. CPC A23P 10/10; A21D 13/47; A21B 3/136

(57) ABSTRACT

A support structure configured to support edible materials includes a top portion and a bottom portion each having at least one indentation configured to support edible material extending adjacent a majority of an outer perimeter of each portion.

### RELATED APPLICATIONS

This application claims priority to U.S. Provisional Patent Application Ser. No. 62/516,247, filed Jun. 7, 2017, the entire disclosure of which is expressly incorporated by reference herein.

### BACKGROUND OF THE PRESENT DISCLOSURE

The present disclosure generally relates to a support structure for edible materials, and more particularly, to a support structure configured to support cookies or other baked goods in various shapes and arrangements.

Gingerbread cookie houses and other similar structures built from edible materials are often held together by edible, royal icing or other edible substances that act as a glue to hold the edible material together. However, the royal icing or glue-like substances are often considered unappealing and often times messy and difficult to use and clean up. As a result, there is a need for a support structure for edible materials that allows consumers to build and decorate edible houses or other structures without the use of royal icing or other glue-like substances to hold the edible material together.

Additionally, gingerbread cookie sheets used for forming gingerbread houses are relatively lightweight compared to other cookie materials. As such, the royal icing or other icing-type materials used to hold together the various sheets or portions of the gingerbread house are able to support the weight of the gingerbread cookie sheets or portions. However, if other cookie materials were to be used, for example chocolate chip cookie sheets or portions, the weight of those different cookie materials may be too great for the royal icing, thereby causing the house structure to collapse under the weight of the cookie portions. As such, there also is a need for a way to build cookie houses or other structures from cookie materials that will support the weight of various cookie types (e.g., chocolate chip cookie material, sugar cookie material, etc.).

### SUMMARY OF THE PRESENT DISCLOSURE

In one embodiment of the present disclosure, a support structure configured to support edible materials comprises a top portion and a bottom portion, where both the first and second portions include at least one indentation configured to receive edible material extending adjacent a majority of a perimeter of each portion.

In one aspect of the support structure, the top portion and the bottom portion together are in the shape of a house.

In another aspect of the support structure, the top and bottom portions together are in the shape of a box.

In a further aspect of the support structure, the box is in the shape of one of a square and a rectangle.

In another aspect of the support structure, the top and bottom portions are in the shape of a heart.

In a further aspect of the support structure, the top portion includes a support surface and at least one raised edge.

In another aspect of the support structure, the support surface extends across a majority of the top portion.

In a further aspect of the support structure, the support surface and the at least one raised edge define the at least one indentation of the top portion.

In another aspect of the support structure, the bottom portion includes a support surface and at least one raised edge.

In a further aspect of the support structure, the support surface and the at least one raised edge define the at least one indentation of the bottom portion.

In another aspect of the support structure, the at least one indentation of the bottom portion is a channel.

In a further aspect of the support structure, the at least one indentation of the top portion is a channel.

In another aspect of the support structure, the top portion further includes a support surface and a bottom edge extending downward from at least a portion of the support surface.

In a yet another aspect of the support structure, the bottom edge and the support surface define the at least one indentation of the top portion.

In a further aspect of the support structure, the bottom portion further includes a support surface and a raised edge extending upward from at least a portion of the support surface, the support surface and the raised edge defining the at least one indentation of the bottom portion.

In another aspect of the support structure, the top portion further includes at least one raised edge extending upward from the support surface.

In a further aspect of the support structure, the at least one indentation of the top portion includes a first indentation and a second indentation, the first indentation being defined by the support surface and the at least one raised edge of the top portion and the second indentation being defined by the bottom edge and the support surface of the top portion.

In another embodiment of the present disclosure, a method of supporting edible materials with a support structure comprising a first portion and a second portion, where each of the first portion and the second portion includes at least one indentation extending adjacent a majority of an outer perimeter of each portion. The method comprises placing edible materials within at least one of the at least one indentation of the first portion and the at least one indentation of the second portion that the edible materials are supported by at least one of the first portion and the second portion, wherein both the at least one indentation of the first portion and the at least one indentation of the second portion are configured to receive edible materials.

In one aspect of the method, the method further comprises placing the first portion on the second portion such that the first portion is supported by the second portion.

In another aspect of the method, at least a portion of the edible materials is supported by both the first portion and the second portion.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 shows a right front perspective view of an embodiment of a support structure of the present disclosure in the shape of a house;

FIG. 2 shows a top view of a slanted surface of a top portion of the support structure of FIG. 1;

FIG. 3 shows a perspective view of a top side support portion of the support structure of FIG. 1;

FIG. 4 shows a perspective view of a top front support portion of the support structure of FIG. 1;

FIG. 5 shows a front view of a front portion of the support structure of FIG. 1;

FIG. 6 shows a side view a side portion of the support structure of FIG. 1;

FIG. 7 shows a perspective view of a bottom left side support portion of the support structure of FIG. 1;

FIG. 8 shows a perspective view of a bottom right side support portion of the support structure of FIG. 1;

FIG. 9 shows a left front perspective view of another embodiment of a support structure of the present disclosure in the shape of a house;

FIG. 10 shows a perspective view of a top portion of another embodiment of a support structure of the present disclosure in the shape of a box;

FIG. 11 shows a perspective view of a bottom portion of the embodiment of the support structure of FIG. 10;

FIG. 12 shows a perspective view of a top portion of another embodiment of a support structure of the present disclosure in the shape of a heart; and

FIG. 13 shows a perspective view of a bottom portion of the embodiment of the support structure of FIG. 12.

Corresponding reference characters indicate corresponding parts throughout the several views, unless otherwise indicated. The exemplifications set out herein illustrate various embodiments of the invention and such exemplifications are not to be construed as limiting the scope of the invention in any manner.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings.

The present disclosure provides various support structures 100, 100′, 200, 300 for supporting edible materials, such as cookies, cake, pastries, etc., in various shapes and/or configurations. Each support structure includes a plurality of channels configured to receive and support the edible materials in the various shapes and configurations. The various support structures of the present disclosure may be made of various materials, for example, food grade plastic, wood, cardboard, or other similar materials.

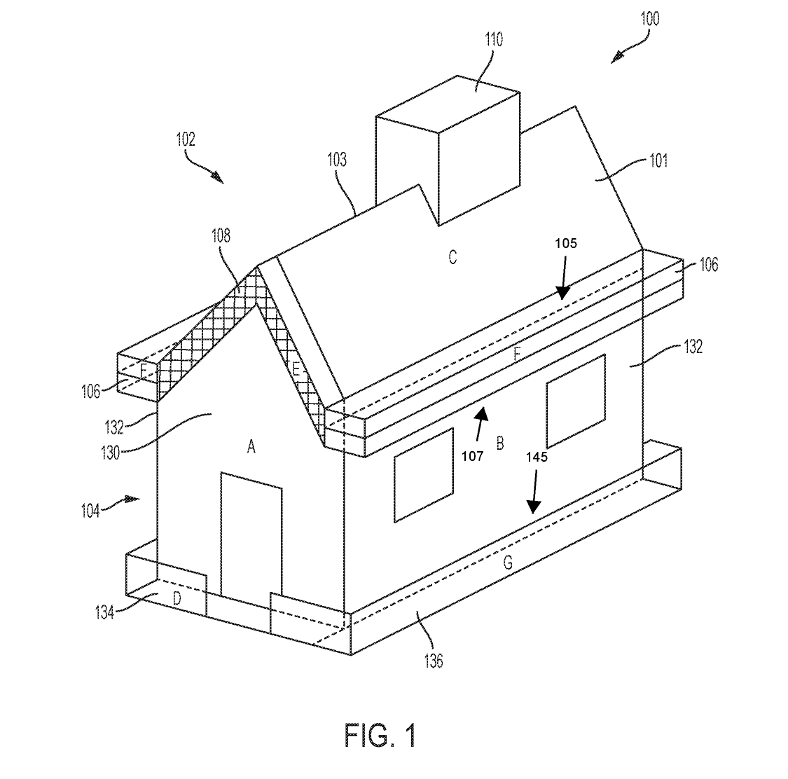

With reference to FIGS. 1-9, support structure 100 is configured to be in the shape of a house, and includes a top portion 102 and a bottom portion 104. Top portion 102 is configured to define the roof or top of the support structure, and bottom portion 104 is configured to define the base or foundation and walls of the support structure.

Referring to FIGS. 1-4, top portion 102 of support structure 100, which defines the roof of the support structure 100, includes first and second slanted surfaces 101 and 103 (“C”), top side support portions 106 (“F”), a top front support portion 108 (“E”), a top rear support portion (not shown), and, in one embodiment, support structure 100 may include a portion defining a chimney 110. In various embodiments, first and second slanted surfaces 101 and 103, top side support portions 106, top front support portion 108, top rear support portion (not shown), and chimney 110 may be removably coupled or snapped together such that each portion may be used as a cookie cutter for providing appropriately shaped cookies for the support structures, while in other various embodiments, they may be integrally formed of a single piece of material.

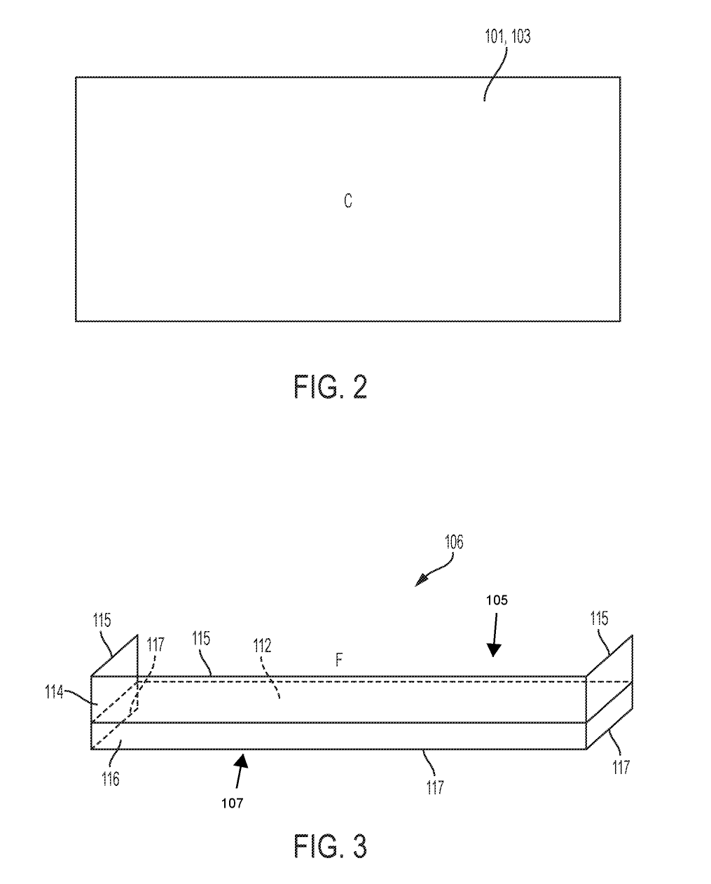

With reference to FIGS. 1 and 2, slanted surfaces 101 and 103 of top portion 102 are configured to support edible material placed thereon which are further supported by top side support portions 106. Slanted surfaces 101 and 103 are configured to couple together to form a peak of the roof of support structure 100. In various embodiments, slanted surfaces 101 and 103 may have varying heights and widths depending on the desired size of support structure 100. In one embodiment, slanted surfaces 101 and 103 of top portion 102 have a height of approximately 3.5 inches and a length of approximately 8 inches, where slanted surfaces 101 and 103 of this size can support a cookie sheet or portion or another edible material that is approximately 3.5 inches tall and approximately 7.5 inches long.

Referring to FIGS. 1 and 3, top side support portion 106 of support structure 100 includes a support surface 112, an upper edge 114, and a lower edge 116. Support surface 112 may extend horizontally to form a flat ledge, wall, or other surface configured to receive and support edible materials. Upper edge 114 extends upward from support surface 112 along three sides of the perimeter of support surface 112 and includes three walls 115 defining an upward-facing indentation or channel 105 of top portion 102. Bottom edge 116 extends downward from support surface 112 along the same three sides of the perimeter of support surface 112 and includes three walls 117 defining a downward-facing indentation or channel 107 of top portion 102 when top portion 102 is supported by bottom portion 104. Channels 105 and 107 generally extend adjacent at least a portion of an outer perimeter of top portion 102. In various embodiments, channels 105 and 107 extend adjacent a majority of the outer perimeter of top portion 102.

Support surface 112 and upper edge 114 are configured to support the edible material upon top portion 102 within indentation 105, and support surface 112 and bottom edge 116 are configured to support a top end of edible material positioned with channels 145 (FIG. 1) of bottom portion 104 within indentation 107 when top portion 102 is supported by bottom portion 104, discussed below.

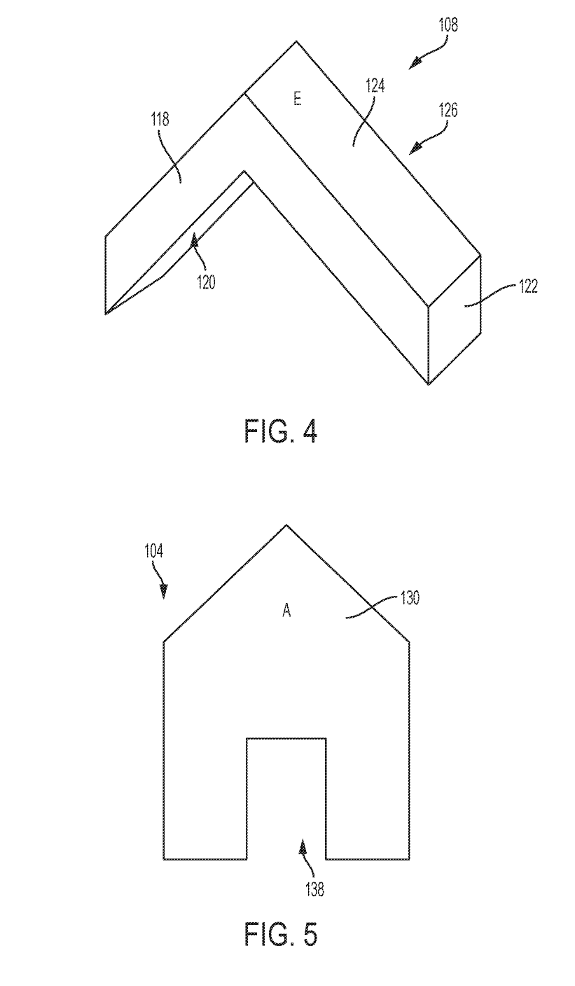

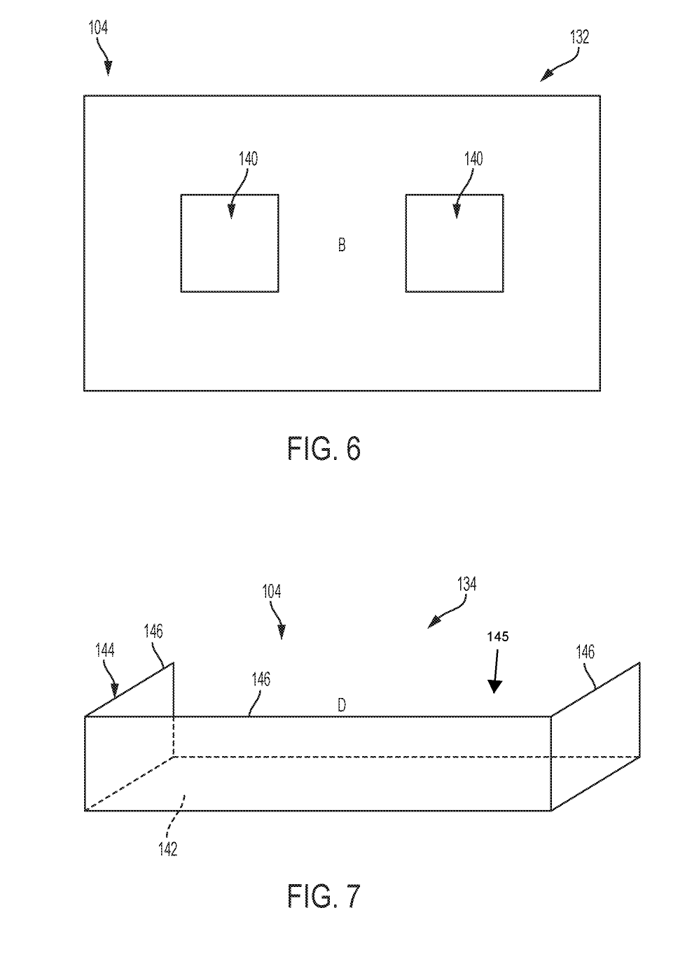

With reference to FIGS. 1 and 4, top front support portion 108 of support structure 100 includes a forward surface 118, side surfaces 122, and top surfaces 124, where a channel 120 is formed between forward surface 118 and front portion 130 of bottom portion 104 and a channel 126 is formed between top surfaces 124 and slanted surfaces 101 and 103 of top portion 102. Cookie or other material portions may be received with channels 120, 126 so as to fully conceal support structure 100 with cookie or other edible material. In various embodiments, the size and shape of top front support portion 108 may vary depending on the desired size of support structure 100 and/or the edible material being supported by support structure 100. In one embodiment, shown in FIGS. 1 and 6, forward surfaces 118, and top surfaces 122 are approximately 3.5 inches long, top surfaces 124 and side surfaces 122 are approximately 1 inch wide, and channels 120 and 126 are approximately ¾ inches deep. Top rear support portion (not shown) is substantially identical to top front support portion 108.

With reference to FIGS. 1 and 5-8, bottom portion 104 of support structure 100, which defines the base of the support structure, includes a front portion 130 (“A”), two side portions 132 (“B”), a rear portion (not shown), a bottom left support portion 134 (“D”), and a bottom right support portion 136 (“G”). In various embodiments, front portion 130, side portions 132, the rear portion, and bottom left and right support portions 134 and 136 may be removably coupled or snapped together, while in other various embodiments, they may be integrally formed of a single piece of material.

Referring to FIGS. 1 and 5, front portion 130 of support structure 100 is a flat piece of material having an opening 138 configured to be a door to the house. In various embodiments, the height and width of front portion 130 may vary depending on the desired size of the house and/or edible material being supported by support structure 100. In one embodiment, front portion 130 has an overall height of approximately 6.5 inches defined to the uppermost surface thereof shown in FIG. 5, a side height of approximately 4-5 inches defined to the uppermost surface of side portions 132 shown in FIG. 6, a width of approximately 5 inches extending from the right to the left sides of front portion 130 shown in FIG. 5, and an angled length of approximately 3.5 inches which extend above side portions 132 and are configured to cooperate with top portion 102 (FIG. 1) for the top or roof portion, and is configured to support edible material of similar dimensions. Rear portion (not shown) of support structure 100 is substantial identical to front portion 130 absent opening 138.

With reference to FIGS. 1 and 6, side portions 132 of support structure 100 are flat pieces of material that may include at least one opening 140 configured to be a window to the house. In one embodiment, side portions 132 include two openings 140. The height and width of side portions 132 may vary depending on the desired size of the house and/or edible material being supported by support structure 100. In one embodiment, side portions 132 are approximately 4.5 inches in height and approximately 7.5 inches in length, and configured to support edible material of similar dimensions.

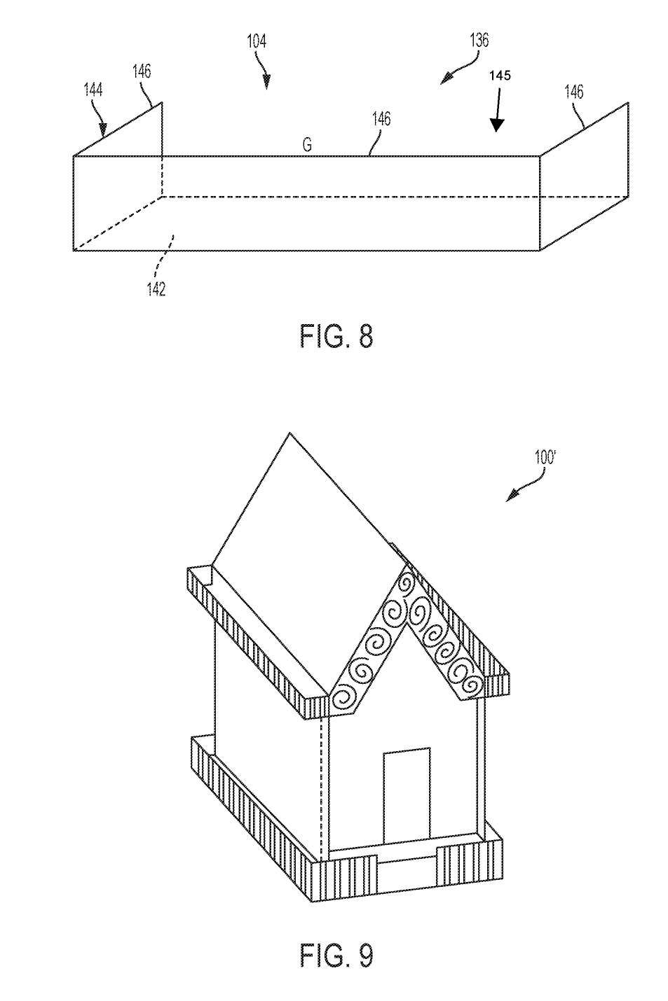

Referring to FIGS. 1, 7, and 8, bottom left and right support portions 134, 136 include a support surface 142, configured to extend horizontally (as shown in FIGS. 7 and 8) for receiving and supporting a cookie or other edible material thereon, and an upper edge 144. Upper edge 144 extends upward from support surface 142 along three sides of the perimeter of support surface 142, and includes three side walls 146 defining an upward-facing indentation or channel 145 of bottom portion 104 which extends adjacent at least a portion of an outer perimeter of bottom portion 104. In various embodiments, channel 145 extends adjacent a majority of the outer perimeter of bottom portion 104. Support surface 134 and upper edge 144 are configured to support the edible material placed against side portion 132 within indentation 145. In addition, when top portion 102 is supported by bottom portion 104, channel 107 of top portion 102 is aligned with channel 145 of bottom portion 104 such that channel 107 of top portion 102 also supports or houses at least a portion of the edible material placed in channel 145 of bottom portion 104 and against side portion 132.

Referring now to FIG. 9, in various embodiments, an alternative embodiment to support structure 100 is shown as support structure 100′ which may include various designs on the various surfaces of the structure. For example, lower edges 116 of top side support portion 106 and forward surface 118 and side surfaces 122 of top front support portion 108 may be designed to look like ornate lattice work of the roof of a house, while upper edges 144 of bottom left and right support portions 134 and 136 may be designed to look like a lattice fence, bushes, or other ornamental designs in front of a house.

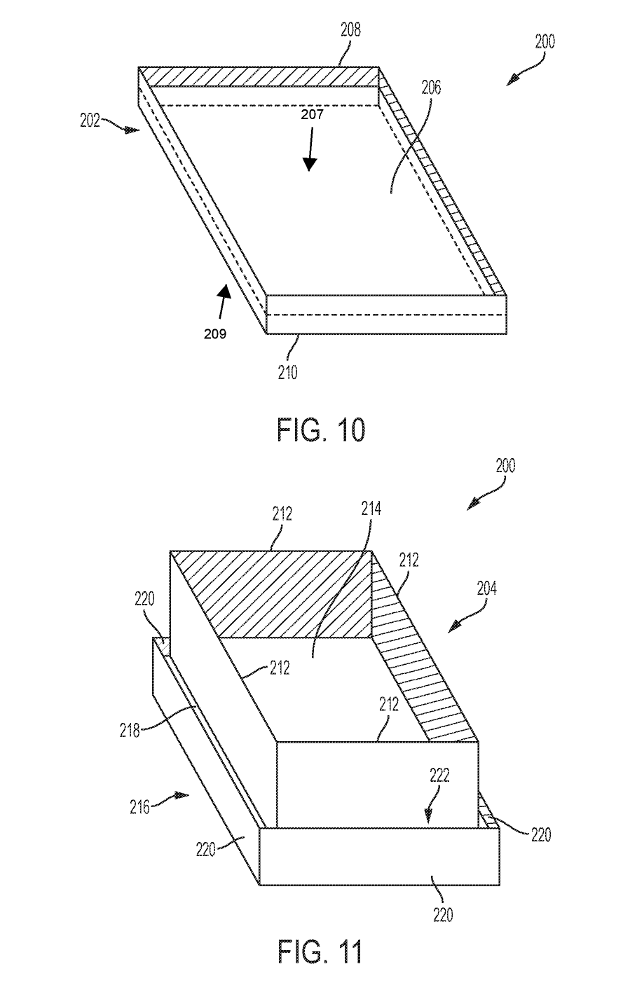

Referring now to FIGS. 10 and 11, an alternative embodiment support structure 200 may be configured to be in the shape of a square or rectangular box and include a top portion 202 and a bottom portion 204. Top portion 202 of support structure 200 includes a support surface 206, an upper edge 208, and a bottom edge 210. Upper edge 208 extends upward from support surface 206 along the perimeter of support surface 206 and bottom edge 210 extends downward from support surface 206 along the perimeter of support surface 206. Support surface 206 and upper edge 208 define an upward-facing indentation 207 and are configured to support the edible material therewithin such that a sheet or portion of cookie or other edible material may be defined in a rectangular shape and positioned on top of support surface 206. In various embodiments, upward-facing indentation 207 extends adjacent an outer perimeter of top portion 202.

Support surface 206 and bottom edge 210 of top portion 202 define a downward-facing indentation 209 with a side wall 212 of bottom portion 204 when top portion 202 is supported by bottom portion 204. In general, indentation 209 extends adjacent an outer perimeter of top portion 202. In various embodiments, top portion 202 acts as a lid for bottom portion 204. Indentation 209 is configured to support a top end of edible material positioned with channels 222 of bottom portion 204, discussed below. In various embodiments, upper edge 208 and bottom edge 210 may be a single piece of material coupled at the middle to support surface 206. In various embodiments, upper edge 208 and/or bottom edge 210 may be used as a cookie cutter or other edible material molder configured to shape edible matter or cookie dough into a shape suitable for being supported by top portion 202 of support structure 200.

Bottom portion 204 of support structure 200 includes a plurality of side walls 212, a bottom surface 214, and a bottom support portion 216. Side walls 212 are coupled to bottom surface 214 and extend upward therefrom. Bottom support portion 216 is also coupled to bottom surface 214 and includes a channel bottom surface 218 and channel walls 220 extending upward therefrom to form an indentation or channel 222 extending around side walls 212. In general, channel 222 extends adjacent an outer perimeter of bottom portion 204, and is configured to support edible material therein and against side walls 212. In various embodiments, a single piece of edible material may extend the length and height of any given side wall 212, while in other various embodiments, a plurality of pieces of edible material may be support by channel 222 along any given side wall 212.

In various embodiments, the various dimensions of top portion 202 and bottom portion 204 may vary depending on the desired size of the box and/or edible material being support by the box. In one embodiment, bottom portion 204 has a length and a width of approximately 8 inches each with a height of approximately 3 inches, and channel 222 height of approximately 1 inch and a width of approximately ¾ inches, and top portion 202 has a length and a width of approximately 1 inch more than the length and the width of bottom portion 204, and upper and bottom edges 208 and 210 have a height of approximately 1 inch.

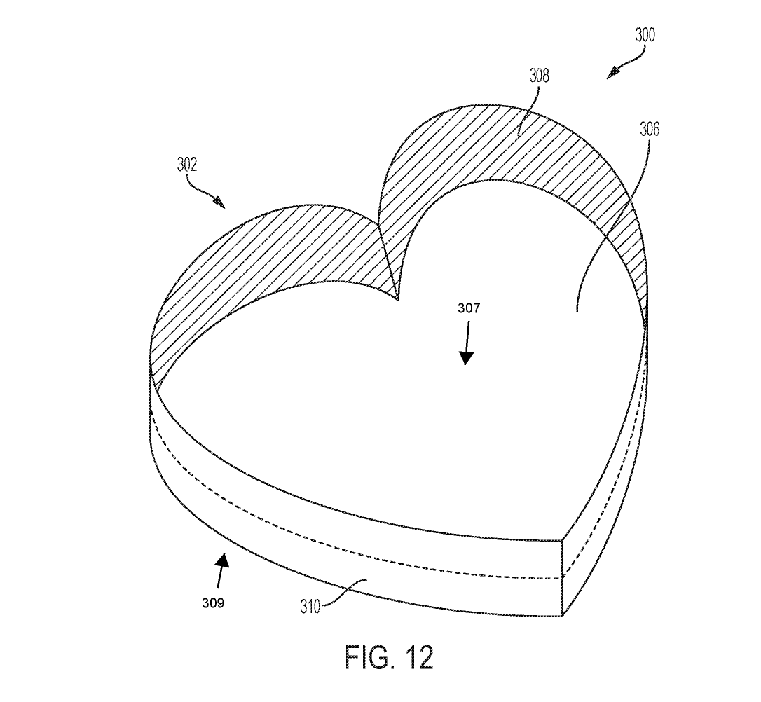

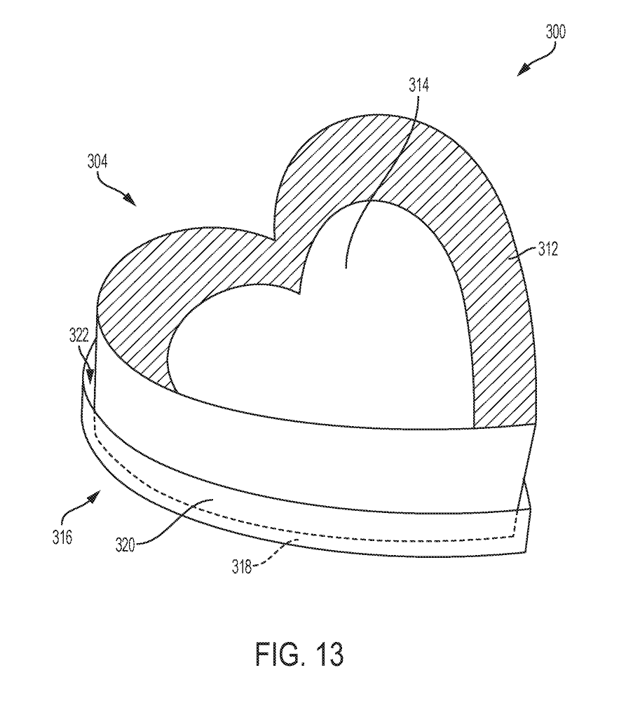

With reference now to FIGS. 12 and 13, a further alternative support structure 300 may be configured in the shape of a heart, and include a top portion 302 and a bottom portion 304. Top portion 302 of support structure 300 includes a support surface 306, an upper edge 308, and a bottom edge 310. Upper edge 308 extends upward from support surface 306 along the perimeter of support surface 306, and bottom edge 310 extends downward from support surface 306 along the perimeter of support surface 306. Support surface 306 and upper edge 308 define an indentation 307 and are configured to support the edible material positioned therewithin such that a sheet or portion of cookie or other edible material may be defined in a heart shape and positioned on top of support surface 306. In various embodiments, upward-facing indentation 307 extends adjacent an outer perimeter of top portion 302.

Support surface 306 and bottom edge 310 of top portion 302 define a downward-facing indentation 309 with a side wall 312 of bottom portion 304 when top portion 302 is supported by bottom portion 304. In general, indentation 309 extends adjacent an outer perimeter of top portion 302. In various embodiments, top portion 302 acts as a lid for bottom portion 304. Indentation 309 is configured to support a top end of edible material positioned with channels 322 of bottom portion 304 when top portion 302 is supported by bottom portion 304, discussed below. In various embodiments, upper edge 308 and/or bottom edge 310 of top portion 302 may be used as a cookie cutter or other edible material molder configured to shape edible matter or cookie dough into a shape suitable for being supported by top portion 302 of support structure 300.

Bottom portion 304 of support structure 300 includes a side wall 312, a bottom surface 314, and a support portion 316. Side wall 312 is coupled to bottom surface 314 along its perimeter edge and extends upward therefrom. Support portion 316 is also coupled to bottom surface 314 and includes a channel bottom surface 318 and a channel wall 320 extending upward therefrom to form an indentation or channel 322 extending around side wall 312. In general, channel 222 extends adjacent an outer perimeter of bottom portion 204, and channel 322 is configured to support edible material therein and against side wall 312. In various embodiments, a plurality of rectangular sections of edible material may be supported by channel 322 along any portion of side wall 312.

In various embodiments, the various dimensions of bottom portion 304 may vary depending on the desired size of the box and/or edible material being support by the box. In one embodiment, bottom portion 304 has a maximum length of approximately 8 inches and a width of approximately 9.5 inches each with a height of approximately 3 inches, and channel 322 height of approximately 1 inch and a width of approximately ¾ inches. Support structure 300 is configured to support edible material around the sides of bottom portion 304 and on the top of top portion 302.

While the present disclosure only provides illustrated embodiments of support structure 100, 100′, 200, 300 in the shape of a house, a box, and a heart, it is within the scope of the present invention that the support structure may be of various shapes, sizes, and configurations such as a pyramid, a cylinder, a triangular prism, a cube, or other various shapes and/or configurations. It is to be appreciated that support structures 100, 100′, 200, 300 may be entirely concealed with cookie or other edible material portions which may be joined together using icing materials. However, various portions of support structures 100, 100′, 200, 300 may be exposed to cooperate with the edible materials to form the shape, look, and overall configuration of a house, box, or heart. In this way, because edible formations may be formed in various shapes and configurations without relying solely on icing to support the weight of the cookie or other edible material portions, support structures 100, 100′, 200, 300 allow for heavier or denser cookie materials to be used and also more complex or ornate designs to be formed from edible materials.

While this invention has been described according to the illustrated design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A support structure configured to support edible materials comprising:
a top portion; and
a bottom portion, wherein both the top portion and the bottom portion each include at least one indentation configured to receive edible material extending adjacent a majority of an outer perimeter of each portion.

2. The support structure of claim 1, wherein the top portion and the bottom portion together are in the shape of a house.

3. The support structure of claim 1, wherein the top and bottom portions together are in the shape of a box.

4. The support structure of claim 3, wherein the box is in the shape of one of a square and a rectangle.

5. The support structure of claim 1, wherein the top and bottom portions are in the shape of a heart.

6. The support structure of claim 1, wherein the top portion includes a support surface and at least one raised edge.

7. The support structure of claim 6, wherein the support surface extends across a majority of the top portion.

8. The support structure of claim 6, wherein the support surface and the at least one raised edge define the at least one indentation of the top portion.

9. The support structure of claim 1, wherein the bottom portion includes a support surface and at least one raised edge.

10. The support structure of claim 9, wherein the support surface and the at least one raised edge define the at least one indentation of the bottom portion.

11. The support structure of claim 1, wherein the at least one indentation of the bottom portion is a channel.

12. The support structure of claim 1, wherein the at least one indentation of the top portion is a channel.

13. The support structure of claim 1, wherein the top portion further includes a support surface and a bottom edge extending downward from at least a portion of the support surface.

14. The support structure of claim 13, wherein the bottom edge and the support surface define the at least one indentation of the top portion.

15. The support structure of claim 14, wherein the bottom portion further includes a support surface and a raised edge extending upward from at least a portion of the support surface, the support surface and the raised edge defining the at least one indentation of the bottom portion.

16. The support structure of claim 13, wherein the top portion further includes at least one raised edge extending upward from the support surface.

17. The support structure of claim 16, wherein the at least one indentation of the top portion includes a first indentation and a second indentation, the first indentation being defined by the support surface and the at least one raised edge of the top portion and the second indentation being defined by the bottom edge and the support surface of the top portion.

18. A method of supporting edible materials with a support structure comprising a first portion and a second portion, where each of the first portion and the second portion includes at least one indentation extending adjacent a majority of an outer perimeter of each portion, the method comprising:
placing edible materials within at least one of the at least one indentation of the first portion and the at least one indentation of the second portion such that the edible materials are supported by at least one of the first portion and the second portion, wherein both the at least one indentation of the first portion and the at least one indentation of the second portion are configured to receive edible materials.

19. The method of claim 18, further comprising placing the first portion on the second portion such that the first portion is supported by the second portion.

20. The method of claim 18, wherein at least a portion of the edible materials is supported by both the first portion and the second portion.
